(19) United States
(12) Patent Application Publication
(10) Pub. No.: US 2010/0011407 A1
(43) Pub. Date: Jan. 14, 2010

(54) METHOD AND SYSTEM FOR PLAYLIST SYNCHRONIZATION

(75) Inventors: Gregory Herlein, San Francisco, CA (US); David Wang, San Francisco, CA (US)

Correspondence Address: Robert D. Shedd, Patent Operations;THOMSON Licensing LLC, P.O. Box 5312, Princeton, NJ, 08543-5312, US

(73) Assignee: Thomson Licensing, Boulogne-Billancourt (FR)

(21) Appl. No.: 12/449,289

(22) PCT Filed: Oct. 25, 2007
(86) PCT No.: PCT/US07/22617

§ 371 Date: Jul. 31, 2009

Related U.S. Application Data
(60) Provisional application No. 60/889,056, filed on Feb. 9, 2007.

(51) Int. Cl. H04N 7/16

(52) U.S. Cl. 725/146

(57) ABSTRACT

Embodiments of the present invention provide a method and system for synchronizing the playlists of department channels or groups of department channels. In one embodiment of the present invention, the playlists of department channels or groups of department channels are synchronized to endpoints defined in a global playlist schedule. That is, channels not having a termination/end point consistent with the endpoints defined by said global playlist schedule are padded with respective filler content (media) to coordinate the termination points of the channels to be synchronized. The amount of filler content needed for each channel is determined respectively for a channel.

### CROSS REFERENCE TO RELATED APPLICATIONS

This application claims the benefit of U.S. provisional patent application No. 60/899,056, filed Feb. 2, 2007, which is herein incorporated by reference in its entirety.

### FIELD OF THE INVENTION

The present invention generally relates to information and content display and distribution and, more particularly, to a method and system for playlist synchronization.

### BACKGROUND OF THE INVENTION

Information and content distribution systems are used to provide information and content to a plurality of end systems. Such systems are constantly evolving and the demand for improved performance is continually on the rise. For example, in video-on-demand applications media content has been made available to and utilized by satellite/cable television subscribers. Typically, subscribers can view at their television via a set-top box the video programs available for selection (sometimes for an additional fee) and upon selection made at the subscriber's set-top-box (STB), the program is sent from the program center to the set-top-box via the cable or satellite network. On occasion, in such video-on-demand systems, a single channel is communicated to all subscriber set-top boxes.

Similarly, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at a respective receiver, such as a set-top-box for each display or group of displays and a speaker for audio systems, typically in the form of playlists. Retailers use the displays and audio systems to present their current offerings or sale information in the form of respective playlists for each of the department channels or groups of channels, while the public spaces sell time on the video displays to advertisers either national or local, knowing that large numbers of consumers will see the presentation.

In various content distribution systems as those described above, the playlists can also include programming for a single channel (e.g., a headline channel) to be communicated to all receivers at determined time periods for the purposes of communicating a synchronized message across all available channels. In such departmental channel and single channel systems, the available content and information is typically displayed according to predetermined schedules. Such predetermined schedules allow for the selling of advertising time and for the organization of scheduled events such as coordinated special advertising periods for specialty and sales items. For example, there may be a point in time within the schedule during which all channels must switch between individual channel programming and a headline channel. Unfortunately, there are many instances in which the media content available does not fit seamlessly within a predetermined schedule. More specifically, in such applications, a switch may occur at the wrong time, for example, in the middle of an advertisement. More specifically, if multiple channels are involved, then the end point will not be at one point in time for all channels. This would result in one or more channels being cut off at the switching point of a predetermined schedule.

### SUMMARY OF THE INVENTION

Embodiments of the present invention address the deficiencies of the prior art by providing a method and system for playlist synchronization.

In one embodiment of the present invention, the playlist of at least two individual channels are synchronized by adding filler content to at least one of the playlists of the at least two individual channels to synchronize the playlists of the at least two individual channels to end at a common endpoint. In one such embodiment of the present invention, the at least two department channels comprise retail advertising channels and the filler content comprises retail advertising media.

In an alternate embodiment of the present invention, the playlists of department channels or groups of department channels are synchronized to endpoints defined in a global playlist schedule. That is, channels not having a termination/end point consistent with the endpoints defined by said global playlist schedule are padded with respective filler content (media) to coordinate the termination points of the channels to be synchronized. The amount of filler content needed for each channel is determined respectively for a channel. In such an embodiment, respective content portions of the department channels are compiled to cause a respective endpoint of the channel playlists the department channels to approach the predetermined endpoint without exceeding the predetermined endpoint. Subsequently, filler content is added to the respective compiled content portions to cause the respective endpoints of the playlists of the department channels to end at a point equal a respective predetermined endpoint.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising in accordance with an embodiment of the present invention;

FIG. 3 depicts a table of respective media files comprising the playlists of two individual (e.g., department) channels for demonstrating an example of a synchronized playlist calculation in accordance with an embodiment of the present invention;

FIG. 4 depicts a table of respective media files comprising the playlists of two individual (e.g., department) channels for demonstrating an example of a synchronized playlist calculation to a global playlist schedule in accordance with an embodiment of the present invention;

FIG. 5 depicts a flow diagram of a method for synchronizing playlists in accordance with an embodiment of the present invention; and

FIG. 6 depicts a table of respective media files comprising the playlists of two individual (e.g., department) channels for demonstrating an example of a synchronized playlist calculation in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and system for playlist synchronization. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any content distribution and playback network such as a video on demand network and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

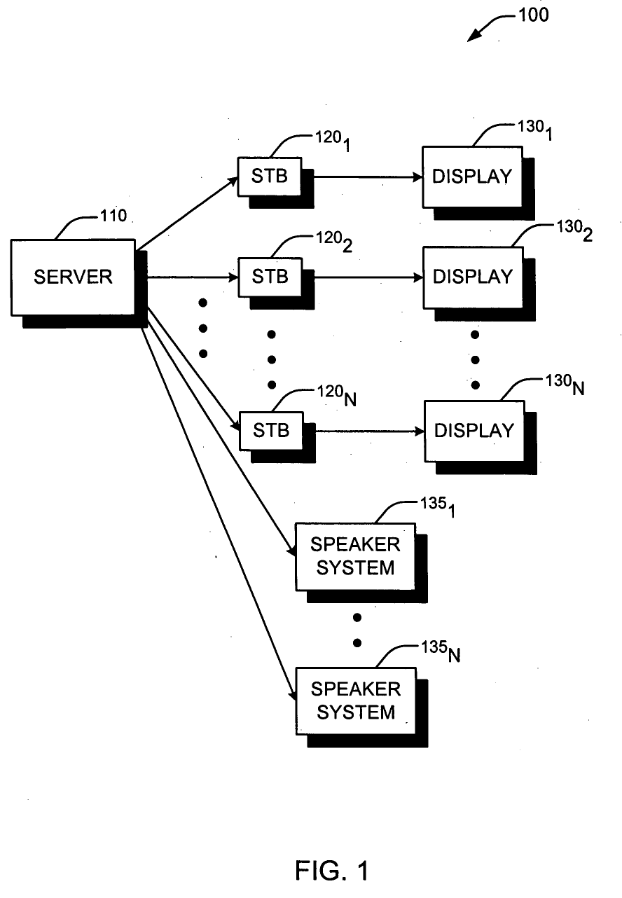

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ, for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

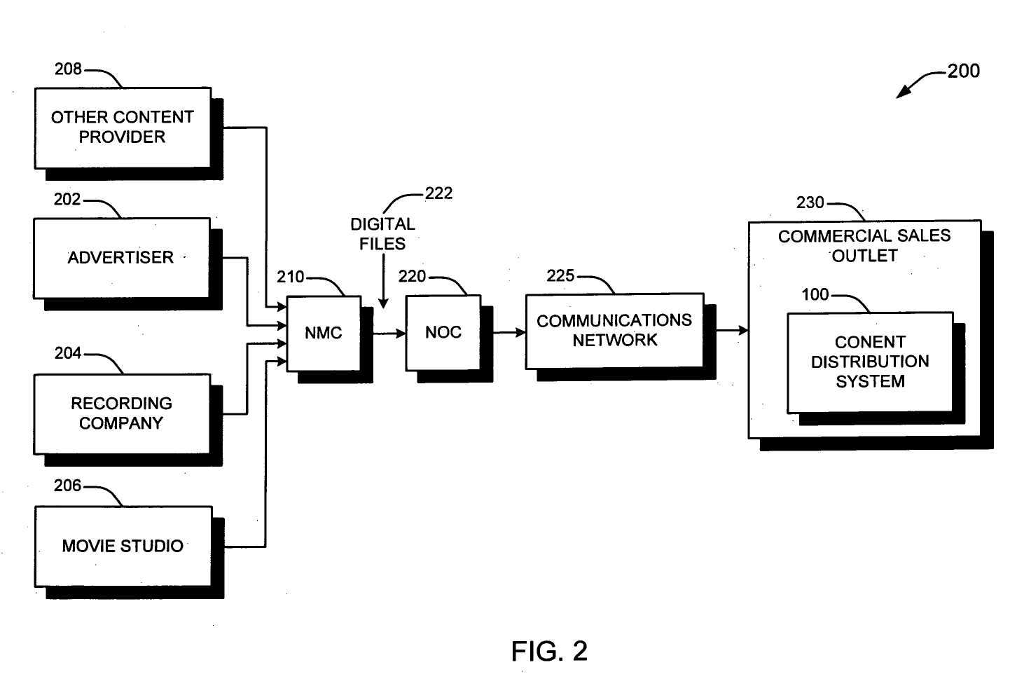

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is in one embodiment of the present invention, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

In various embodiments of the present invention, the various streams can be organized in the form of playlists to be communicated to the various receivers throughout the store and displayed on specific displays in a predetermined order and frequency. That is, embodiments of the present invention provide a method and system for playlist synchronization including a determination of synchronized playlists through the use of filler media needed for accomplishing the requirements of a predetermined playlists schedule. It should be noted that the terms local, department and individual channel are to be considered interchangeable throughout the teachings of this disclosure.

The synchronization of the present invention can be determined or calculated at a remote server, such as the NMC 210 or the NOC 220, or at a local server such as the server 110 of the content distribution system 100 of FIG. 1. In addition, the synchronization of the present invention can be determined or calculated using a separate controller, similar to a general purpose computer or server, provided for performing the inventive concepts of the present invention. In various embodiments of the present invention, a controller or server contains information regarding a predetermined schedule and available individual channel content and common channel content for performing the various inventive aspects of the present invention. More specifically, in various embodiments of the present invention, a controller or server contains information regarding a global playlist schedule for the respective individual channel and common channel(s), such as global playlist timing, individual media clip lengths, media clip durations for each of the individual channels and a common channel, desired durations for the respective individual channel playlists and the common channel, for performing the various inventive aspects of the present invention.

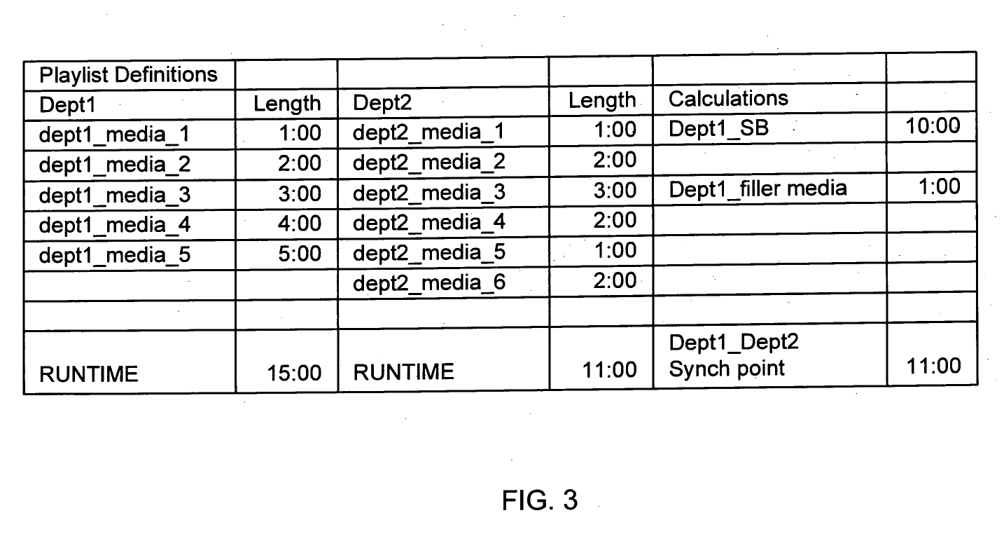

In a first embodiment of the present invention, individual department channels or groups of channels are synchronized to a common point in time. For example, FIG. 3 depicts a table of respective media files comprising playlist definitions for the playlists of two individual (e.g., department) channels for demonstrating an example of a synchronized playlist calculation in accordance with an embodiment of the present invention. That is, as illustrated in FIG. 3, programming channels are comprised of a compilation of respective media files that are intended for specific channels. The media files can contain, for example, media content specific to a product to be advertised by that channel. In FIG. 3, the Dept1 playlist includes five media files of various lengths, with a total runtime of fifteen minutes. The Dept2 playlist includes six media files of various lengths, with a total runtime of eleven minutes.

In the embodiment of FIG. 3, it is assumed that the starting time for the synchronized playlist calculation in accordance with the present invention starts at a point of 0:00 in time. A synchronization point is then selected for the two department channels. For example, a synchronization point can be the endpoint of the compilation of a specific number of media files for either channel. For example, in FIG. 3 the synchronization point is selected as the endpoint of the compilation of the six media files of the playlist of Dept2, which equals eleven (11:00) minutes. As such and keeping in mind the parameters presented in FIG. 3, synchronized local channel playlists can be determined as follows.

For channel one (Dept1), the first four media clips of channel one are added to approach as close as possible to the endpoint of the playlist of Dept2, without exceeding endpoint, to determine a Sum Before. In the example of FIG. 3, the first four media clips of channel one equal a total length of ten minutes. Subsequently, filler media having a length of one minute is added to the playlist of channel one such that the current playlist of channel one ends at a point in time equal to the endpoint of the playlist of Dept2, in this example, 11:00 minutes. With the application of the aspects of the above described embodiment of the present invention, the playlist of Dept1 and Dept2 are synchronized to a common endpoint.

In various embodiments of the present invention, a common point for synchronization can be a predetermined point in time. For example, common points for synchronization can be defined in a predetermined playlist schedule. That is, in accordance with an embodiment of the present invention, initially a global playlist schedule is determined. The global playlist schedule can comprise a timing schedule for controlling the various channels or groups of channels of, for example, the content distribution system 100 of FIG. 1 for determining the absolute time and duration for which specific content must play. For example, in one embodiment of the present invention various channels or groups of channel exist in the content distribution system 100 of FIG. 1 for playing advertising content specific to products located in proximity to respective display devices. A global schedule can be predetermined for scheduling, for example, sale information for specific products or advertising material most effective for a specific time of the day or other scheduled event. The global schedule identifies points in time for transitions in content information for each of the respective channels or groups of channels.

However, any such systems that use global schedules can suffer from a switch that may occur at the wrong time, for example, in the middle of an advertisement. More specifically, a transition point in the predetermined global schedule may not coincide with available content for a particular channel or group of channels. This would result in one or more channels being cut off at the switching point of a predetermined schedule.

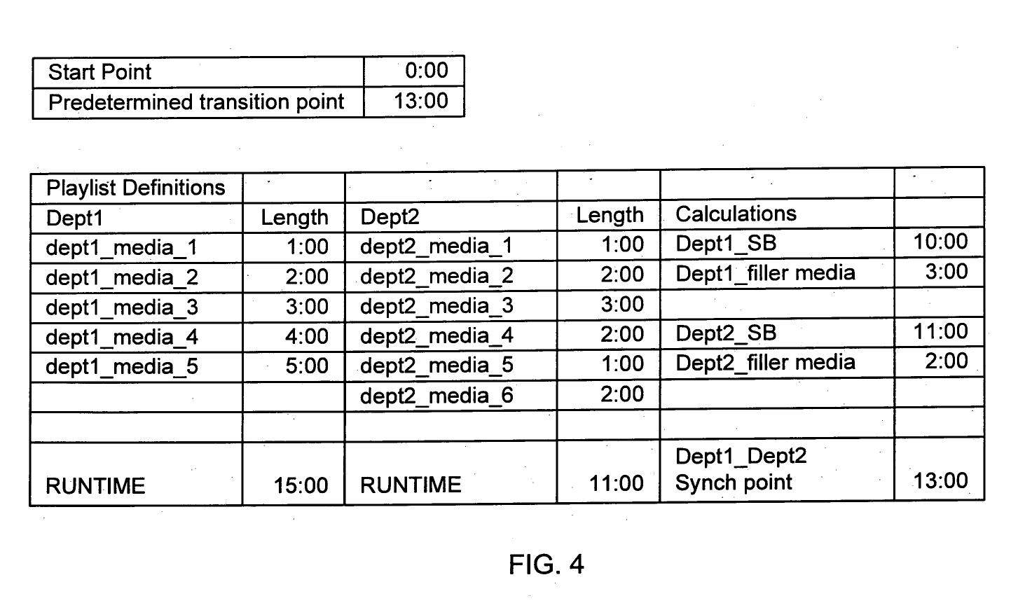

As such and in accordance with various aspects of embodiments of the present invention, filler media is added to the playlist of one or more channels or groups of channels to synchronize the respective channels such that the playlists of the individual channels end, at the predetermined transition times according to the predetermined global schedule. Filler media is a media which is used to pad a programming channel (View) until the length of the View approaches the endpoint as determined by the global schedule. For example, FIG. 4 depicts a table of respective media files comprising playlist definitions of the playlists of two individual (e.g., department) channels for demonstrating an example of a synchronized playlist calculation to a global playlist schedule in accordance with an embodiment of the present invention. That is, as illustrated in FIG. 4, programming channels are comprised of a compilation of respective media files that are intended for specific channels. The media files can contain, for example, media content specific to a product to be advertised by that channel. In FIG. 4, the Dept1 playlist includes five media files of various lengths, with a total runtime of fifteen minutes. The Dept2 playlist includes six media files of various lengths, with a total runtime of eleven minutes.

In the embodiment of FIG. 4, it is assumed that the starting time for the synchronized playlist calculation in accordance with the present invention starts at a point of 0:00 in time. In FIG. 4 it is also assumed that a transition point in time for the playlists of Dept1 and Dept2 is scheduled in the global schedule at a point of 13:00 minutes in time. As such and keeping in mind the parameters presented in FIG. 4, synchronized local channel playlists can be determined as follows.

For channel one (Dept1), the first four media clips of channel one are added to approach as close as possible to the scheduled transition point, without exceeding the scheduled transition point, to determine a Sum Before. In the example of FIG. 4, the first four media clips of channel one equal a total length of ten minutes. Subsequently, filler media having a length of three minutes is added to the playlist of channel one such that the current playlist of channel one ends at a point in time equal to the transition point defined by the predetermined global schedule, in this example, 13:00 minutes.

Similarly, a Sum Before is determined for channel two (Dept2) by adding the first six media clips of channel two, which equals a total of eleven minutes. As depicted in FIG. 4, available filler media having a total length of two minutes is added to the playlist of channel two to cause the current playlist of channel two to end at a point in time equal to the transition point defined by the predetermined global schedule, in this example, 13:00 minutes. As such and because of the application of the aspects of the above described embodiment of the present invention, media content is no longer cut off at the switching point of a predetermined schedule, such as the predetermined global schedule because the playlists of the individual channels have been synchronized to the transition point defined by the predetermined global schedule.

In accordance with various embodiments of the present invention, filler media can include video content in the form of advertisements, store announcements, and the like. In addition, filler media can be provided in substantially any length for extending channel content to synchronize channel views to a predetermined transition or switch point.

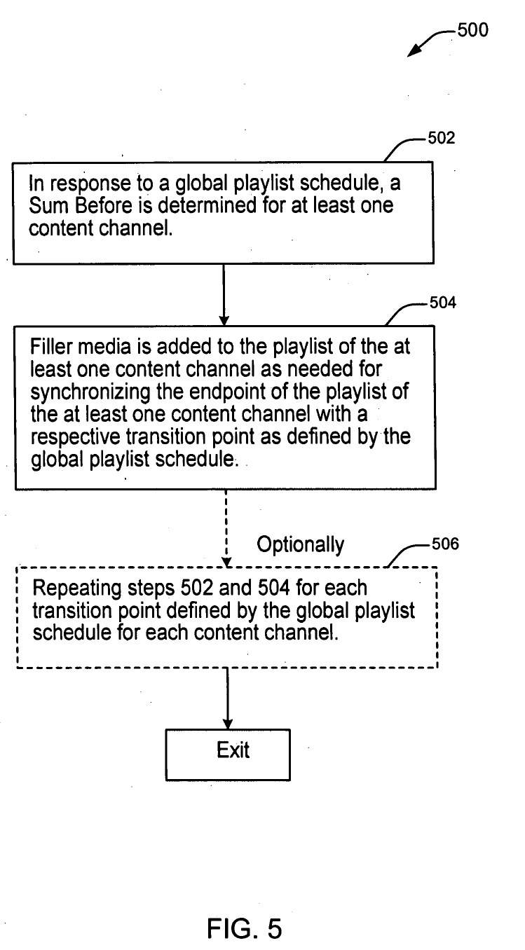

FIG. 5 depicts a flow diagram of a method 500 for synchronizing playlists in accordance with an embodiment of the present invention. In response to a global playlist schedule, the method 500 begins at step 502 during which a Sum Before is determined for at least one content channel. As described above, a respective transition point for each content channel is defined by the global playlist schedule and a Sum Before is determined for each channel by adding available respective media clips of a channel to approach as close as possible to the scheduled transition point, without exceeding the transition point. The method then proceeds to step 504.

At step 504, filler media is added to the channels as needed for synchronizing the playlists of the channels with a respective transition point as defined by the global playlist schedule. It should be noted that in various embodiments of the present invention, a channel may include more than one transition point defined by the global playlist schedule. As such, in such an embodiment the method 500 then optionally proceeds to step 506.

At step 506, steps 502 and 504 of the method 500 are repeated for each scheduled transition point defined by the global playlist schedule for each channel or group of channels such that media content is no longer cut off at the switching point of a predetermined schedule. The method 500 is then exited.

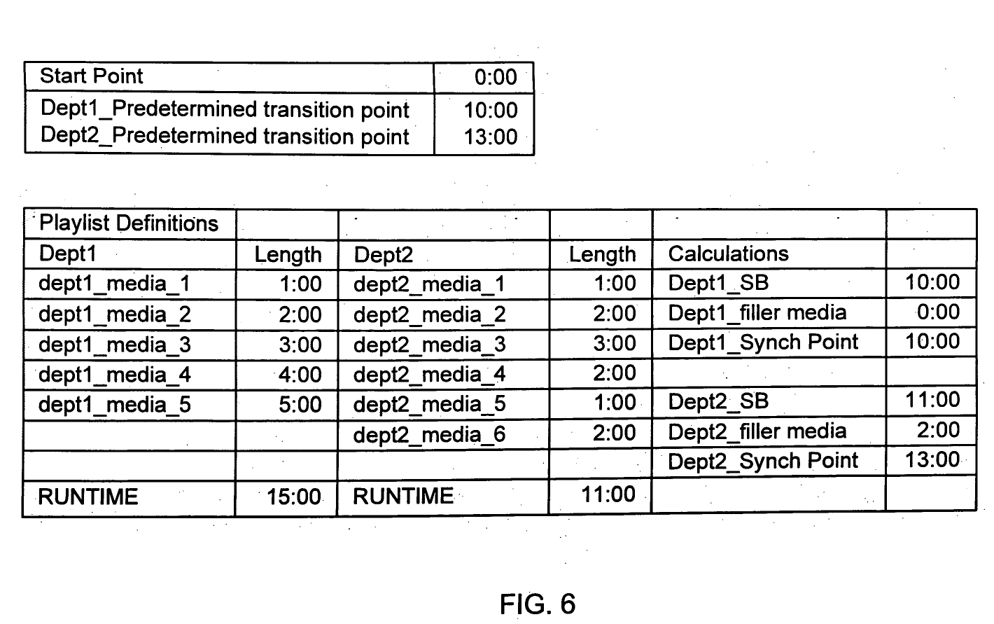

In an alternate embodiment of the present invention, the concepts of the present invention are applied to content channels having different transition points as defined by a predetermined schedule. For example, FIG. 6 depicts a table of respective media files comprising the playlists of two individual (e.g., department) channels for demonstrating an example of a synchronized playlist calculation in accordance with an alternate embodiment of the present invention. That is, as illustrated in FIG. 6, programming channels are comprised of a compilation of respective media files that are intended for specific channels. The media files can contain, for example, media content specific to a product to be advertised by that channel. In FIG. 6, the Dept1 playlist includes five media files of various lengths, with a total runtime of fifteen minutes. The Dept2 playlist includes six media files of various lengths, with a total runtime of eleven minutes.

In the embodiment of FIG. 6, it is assumed that the starting time for the synchronized playlist calculation in accordance with the present invention starts at a point of 0:00 in time. In FIG. 6 it is also assumed that a first transition point in time for the playlist of Dept1 is at 10:00 minutes and that a first transition point in time for the playlist of Dept2 is scheduled in the global schedule at a point of 13:00 minutes. As such and keeping in mind the parameters presented in FIG. 6, synchronized local channel playlists can be determined as follows.

For channel one (Dept1), the first four media clips of channel one are added to approach as close as possible to the scheduled transition point, without exceeding the scheduled transition point, to determine a Sum Before. In the example of FIG. 6, the first four media clips of channel one equal a total length of ten minutes. As such, in the embodiment of FIG. 6, no filler media is added to the current playlist of channel one as the compilation of the first four media clips end at a point in time equal to the transition point defined by the predetermined global schedule for channel one, in this example, 10:00 minutes.

Similarly, a Sum Before is determined for channel two (Dept2) by adding the first six media clips of channel two, which equals a total of eleven minutes. As depicted in FIG. 6, available filler media having a total length of two minutes is added to the playlist of channel two to cause the current playlist of channel two to end at a point in time equal to the transition point defined by the predetermined global schedule for channel two, in this example, 13:00 minutes. As such and because of the application of the aspects of the above described embodiment of the present invention, media content is no longer cut off at the switching point of a predetermined schedule, such as the predetermined global schedule because the playlists of the individual channels have been synchronized to the respective transition points defined by the predetermined global schedule.

Although in various embodiments of the present invention described herein filler media is described as being added to the end of a playlist, in accordance with the present invention, filler media can be added to the beginning, the end or anywhere within a playlist to synchronize playlists in accordance with the concepts of the present invention.

Having described various embodiments for a method and system for playlist synchronization (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for synchronizing the playlists of at least two department channels, comprising:
adding filler content to at least one of the playlists of said at least two department channels to synchronize the playlists.

2. The method of claim 1, wherein the playlists of said at least two respective department channels are synchronized to respective endpoints defined in a playlist schedule.

3. The method of claim 1, wherein the playlists of said at least two respective department channels are synchronized to the endpoint of one of said at least two department channels.

4. The method of claim 1, wherein said at least two department channels comprise retail advertising channels.

5. The method of claim 4, wherein said filler content comprises retail advertising media.

6. A method for synchronizing a playlist of at least one department channel to a predetermined endpoint, comprising:
compiling content portions of said at least one department channel to cause an endpoint of the playlist of said at least one department channel to approach said predetermined endpoint without exceeding said predetermined endpoint; and
adding filler content to the compiled content portions to cause the endpoint of the playlist of said at least one department channel to equal said predetermined endpoint.

7. The method of claim 6, wherein said predetermined endpoint is defined in a global playlist schedule.

8. The method of claim 7, wherein said global playlist schedule defines a plurality of predetermine endpoints for the playlist of said at least one department channel.

9. The method of claim 8, wherein respective content portions of said at least one department channel are compiled to cause a respective endpoint of the playlist of said at least one department channel to approach a respective one of said predetermined endpoints without exceeding said respective one of said predetermined endpoints for each of said predetermined endpoints and wherein filler content is added to respective ones of the compiled content portions to cause respective endpoints of the playlist of said at least one department channel to equal said respective one of said predetermined endpoints.

10. The method of claim 6, wherein said at least one department channel comprises a plurality of department channels.

11. The method of claim 10, wherein at least two of said plurality of department channels comprise different predetermined endpoints.

12. The method of claim 6, wherein said at least one department channel comprises a retail advertising channel.

13. The method of claim 12, wherein said filler content comprises retail advertising media.

14. A system for synchronizing a playlist of at least one department channel to a predetermined endpoint, comprising:
at least one content source for providing content for said at least one department channel and filler content; and
a controller including a memory for storing at least information regarding the content for said at least one department channel, the filler content, and program instructions, and a processor for executing said program instructions, the controller adapted to perform the steps of;
compiling content portions of said at least one department channel to cause an endpoint of the playlist of said at least one department channel to approach said predetermined endpoint without exceeding said predetermined endpoint; and
adding filler content to the compiled content portions to cause the endpoint of the playlist of said at least one department channel to equal said predetermined endpoint.

15. The system of claim 14, wherein said at least one content source comprises at least one of an advertiser, a recording company and a movie studio.

16. The system of claim 14, wherein said controller comprises a server of at least one of a network management center, a network operations center and a content distribution network.

17. The system of claim 14, wherein said predetermined endpoint is defined in a global playlist schedule.

18. The system of claim 17, wherein information regarding said global playlist schedule is contained in said memory.

19. The system of claim 18, wherein said global playlist schedule defines a plurality of predetermine endpoints for the playlist of said at least one department channel.

20. The system of claim 19, wherein respective content portions of said at least one department channel are compiled to cause a respective endpoint of the playlist of said at least one department channel to approach a respective one of said predetermined endpoints without exceeding said respective one of said predetermined endpoints for each of said predetermined endpoints and wherein filler content is added to respective ones of the compiled content portions to cause respective endpoints of the playlist of said at least one department channel to equal said respective one of said predetermined endpoints.

21. The system of claim 14, wherein said at least one department channel comprises a plurality of department channels.

22. The system of claim 21, wherein at least two of said plurality of department channels comprise different predetermined endpoints.

23. The system of claim 14, wherein said at least one department channel comprises a retail advertising channel.

24. The system of claim 23, wherein said filler content comprises retail advertising media.

25. A system for synchronizing the playlists of at least two department channels, comprising:
at least one content source for providing content for said at least two department channels and filler content; and
a controller including a memory for storing at least information regarding the content for said at least two department channels, the filler content, and program instructions, and a processor for executing said program instructions, the controller adapted to perform the step of;
adding filler content to at least one of the playlists of said at least two department channels to synchronize the playlists.

26. The system of claim 25, wherein the playlists of said at least two respective department channels are synchronized to respective endpoints defined in a playlist schedule.

27. The system of claim 25, wherein the playlists of said at least two respective department channels are synchronized to the endpoint of one of said at least two department channels.

28. The system of claim 25, wherein said at least two department channels comprise retail advertising channels.

29. The system of claim 28, wherein said filler content comprises retail advertising media.
